(19) United States
(12) Patent Application Publication
(10) Pub. No.: US 2012/0133813 A1
(43) Pub. Date: May 31, 2012

(54) IMAGE PICKUP APPARATUS

(75) Inventor: Akihiko Nagano, Ichihara-shi (JP)

(73) Assignee: CANON KABUSHIKI KAISHA, Tokyo (JP)

(21) Appl. No.: 13/295,728

(22) Filed: Nov. 14, 2011

(30) Foreign Application Priority Data
Nov. 29, 2010 (JP) 2010-264667

(51) Int. Cl. H04N 5/335

(52) U.S. Cl. 348/311; 348/E05.045

(57) ABSTRACT

The image pickup apparatus includes an image sensor. A first focus controller performs first focus control with a contrast detection method by using a first signal output from the image sensor. A second focus controller detects a focus state of an image-taking optical system with a phase difference detection method by using a second signal output from a focus detection element (image sensor), and performs second focus control based on the detected focus state. A charge accumulation controller causes the image sensor to alternately and repeatedly perform a first charge accumulation operation for producing the first signal and output of the first signal, and causes the focus detection element to perform a second charge accumulation operation for producing the second signal in a period between two consecutive ones of the first charge accumulation operations.

### BACKGROUND OF THE INVENTION

1. Field of the Invention

The present invention relates to an image pickup apparatus such as a digital still camera and a video camera, and particularly to an image pickup apparatus capable of performing focus control by using an output from an image sensor.

2. Description of the Related Art

Image pickup apparatuses that capture moving images by using an image sensor employ a contrast detection method as a focus detection method or an autofocus (AF) method. The contrast detection method produces a signal showing a contrast evaluation value from a high-frequency component of a moving image (video) signal produced by using an output signal from the image sensor, and detects a position of a focus lens where the contrast evaluation value, which varies with movement of the focus lens, becomes maximum as an in-focus position. However, the contrast detection method causes the focus lens to perform minute reciprocal movement (wobbling) to determine a direction of the in-focus position (in-focus direction) based on changes of the contrast evaluation value, and moves the focus lens in the in-focus direction to search for the in-focus position. Therefore, the contrast detection method needs a certain length of time to detect the in-focus position.

Japanese Patent Laid-Open No. 2005-121819 discloses an image pickup apparatus that first determines the in-focus direction of the focus lens by using a phase difference detection method, and then moves the focus lens in the determined in-focus direction to search for the in-focus position. Such an AF method is called a hybrid AF method, and is capable of determining the in-focus direction without the wobbling of the focus lens. Thus, the hybrid AF method can reduce the length of time to obtain an in-focus state as compared with the case of determining the in-focus direction by the wobbling of the focus lens.

However, the above-mentioned hybrid AF method uses the phase difference detection method only for the determination of the in-focus direction. Therefore, the hybrid AF method cannot reduce a length of time required for searching for the in-focus position by the contrast detection method after the determination of the in-focus direction.

Moreover, in the hybrid AF method, if an subject (object to be captured) moves in a direction closer to or away from the image pickup apparatus during the search for the in-focus position by the contrast detection method, the apparatus may endlessly keep searching for the in-focus position, and may not finally be able to obtain the in-focus state.

### SUMMARY OF THE INVENTION

The present invention provides a hybrid AF image pickup apparatus using the contrast detection method and the phase difference detection method, which is capable of reducing the length of time required for obtaining the in-focus state as compared with conventional apparatuses, and of performing good focus control with respect to a moving object.

The present invention provides as one aspect thereof an image pickup apparatus including an image sensor photoelectrically converting an object image formed by an image-taking optical system, a first focus controller configured to perform first focus control with a contrast detection method by using a first signal output from the image sensor, a second focus controller configured to detect a focus state of the image-taking optical system with a phase difference detection method by using a second signal output from a focus detection element that is one of the image sensor and a photoelectric conversion element provided separately from the image sensor, and configured to perform second focus control based on the detected focus state, and a charge accumulation controller configured to cause the image sensor to alternately and repeatedly perform a first charge accumulation operation for producing the first signal and output of the first signal, and configured to cause the focus detection element to perform a second charge accumulation operation for producing the second signal in a period between two consecutive ones of the first charge accumulation operations.

The present invention provides as another aspect thereof a control method of an image pickup apparatus that includes an image sensor photoelectrically converting an object image formed by an image-taking optical system. The method includes a step of performing first focus control with a contrast detection method by using a first signal output from the image sensor, a step of detecting a focus state of the image-taking optical system with a phase difference detection method by using a second signal output from a focus detection element that is one of the image sensor and a photoelectric conversion element provided separately from the image sensor, and of performing second focus control based on the detected focus state, and a step of causing the image sensor to alternately and repeatedly perform a first charge accumulation operation for producing the first signal and output of the first signal, and of causing the focus detection element to perform a second charge accumulation operation for producing the second signal in a period between two consecutive ones of the first charge accumulation operations.

Further features and aspects of the present invention will become apparent from the following description of exemplary embodiments with reference to the attached drawings.

### BRIEF DESCRIPTION OF THE DRAWINGS

FIG. 1 is a block diagram showing the configuration of a camera system including a camera that is an embodiment of the present invention and an interchangeable lens attached to the camera.

FIGS. 2A and 2B show wobbling in a contrast AF performed in the camera of the embodiment.

FIGS. 3A and 3B show the structure of image pickup pixels in the camera of the embodiment.

FIGS. 4A and 4B show the structure of focus detection pixels in the camera of the embodiment.

FIG. 5 shows image signals used in phase difference focus detection performed in the camera of the embodiment.

FIGS. 6A and 6B show object following in a hybrid AF performed in the camera of the embodiment.

FIG. 7 is a flowchart showing an entire AF process performed in the camera of the embodiment.

FIG. 8 is a flowchart showing a hybrid AF process in the camera of the embodiment.

FIG. 9 shows pixel arrangement of an image sensor used in the camera of the embodiment.

### DESCRIPTION OF THE PREFERRED EMBODIMENTS

Exemplary embodiments of the present invention will hereinafter be described with reference to the accompanying drawings.

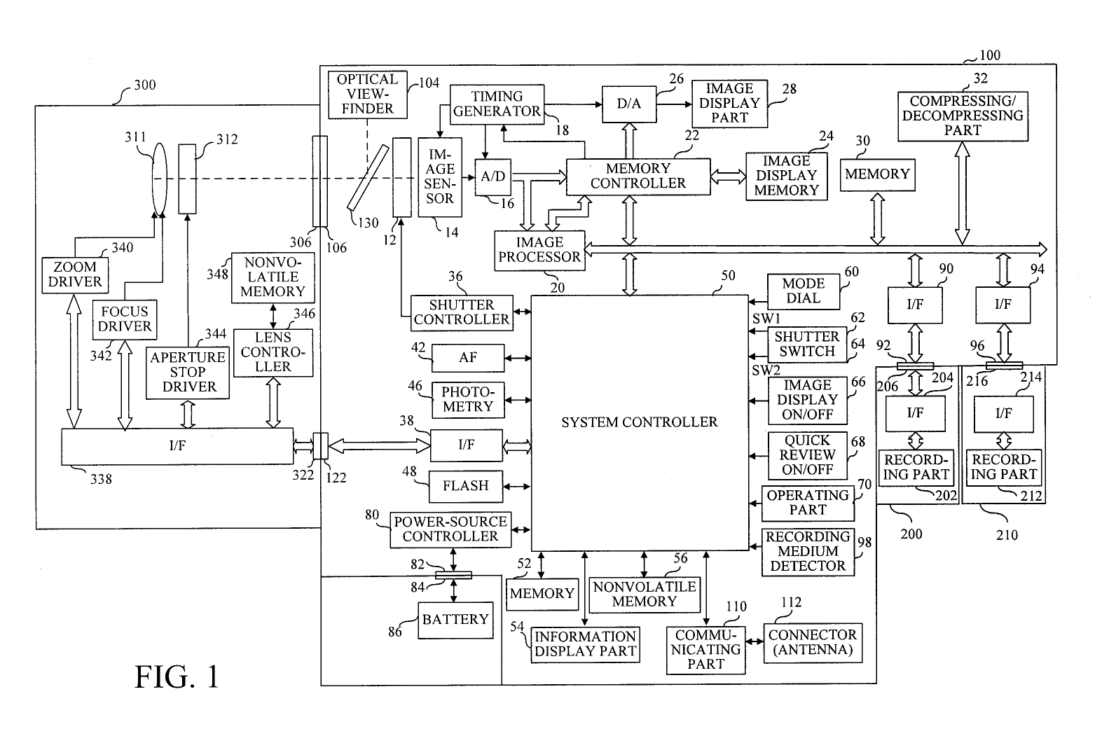

FIG. 1 shows the configuration of a camera system that includes a single-lens reflex digital camera 100 as an image pickup apparatus that is an embodiment of the present invention and an interchangeable lens 300 detachably attachable to the camera 100. The camera 100 is capable of capturing still images and moving images (video).

Reference numerals 306 and 106 denote mounts respectively provided to the interchangeable lens 300 and the camera 100, the mounts 306 and 106 being mutually mechanically coupled and decoupled, that is, attached and detached.

The interchangeable lens 300 contains an image-taking optical system constituted by plural lenses 311 and an aperture stop 312. The lenses 311 include a zoom lens and a focus lens (focus optical element). The image-taking optical system is hereinafter also denoted by reference numeral 311.

In the camera 100, reference numeral 130 denotes a main mirror that reflects a part of a light flux from the image-taking optical system 311 toward an optical viewfinder 104 and transmits a remaining part of the light flux toward an image sensor (image pickup element) 14 in a state of being disposed in an optical path from the image-taking optical system 311 as shown in the figure. The main mirror 130 disposed in this state enables a user to observe an object through the optical viewfinder 104. The main mirror 130 retracts out of the optical path when main image capturing (acquisition of a recording still image) and moving image capturing are performed.

The image sensor 14 is a photoelectric conversion element such as a CCD sensor or a CMOS sensor which photoelectrically converts an object image as an optical image formed by the light flux from the image-taking optical system 311 to output an electric signal. Moreover, the image sensor 14 is also used as a focus detection element in this embodiment. Reference numeral 12 is a shutter that controls an exposure amount of the image sensor 14.

Reference numeral 16 denotes an A/D converter that converts an analog image pickup signal output from the image sensor 14 into a digital image pickup signal.

Reference numeral 18 denotes a timing generator that supplies a clock signal to the image sensor 14, the A/D converter 16 and a D/A converter 26 described later. The timing generator 18 is controlled by a memory controller 22 and a system controller 50 described later.

Reference numeral 20 denotes an image processor that performs a pixel interpolation process, a color conversion process, an AWB (auto white balance) process and the like on the digital image pickup signal from the A/D converter 16 or the memory controller 22 to produce a video signal corresponding to the object image formed on the image sensor 14.

The image processor 20 sends the video signal or the digital image pickup signal from the A/D converter 16 to an AF part 42 and a photometry part 46 through the system controller 50.

The AF part 42 performs focus control of the image-taking optical system 311 by a contrast detection method by using the video signal input thereto. Moreover, the AF part 42 performs, by using signal components corresponding to output signals from focus detection pixels (described later) of the input digital image pickup signal, detection of a focus state (focus detection) of the image-taking optical system 311 by a phase difference detection method and performs focus control based on the detected focus state.

The video signal is produced by using output signals (first signals) from image pickup pixels described later provided in the image sensor 14, so that the focus control by the contrast detection method can be said that it is performed by using the output signals from the image pickup pixels. Moreover, the use of the signal components corresponding to the output signals (second signals) from the focus detection pixels, the output signals being a part of the digital image pickup signal, is synonymous with the use of the output signal of the focus detection pixel. The AF part 42 corresponds to a first focus controller and a second focus controller.

In the following description, the focus control by the contrast detection method is referred to as “contrast AF”. Moreover, the focus detection by the phase difference detection method is referred to as “phase difference focus detection”, and the focus control by the phase difference detection method is referred to as “phase difference AF”. Generally, the focus control by the phase difference detection method includes the focus detection by the phase difference detection method and movement (position) control of the focus lens based on the focus detection result. However, in this embodiment, only the movement control of the focus lens based on the focus detection result is called the phase difference AF.

The system controller 50 is capable of communicating with a lens controller 346 in the interchangeable lens 300 via camera side and lens side communication terminals 122 and 322 and camera side and lens side interfaces 38 and 338.

The system controller 50 controls the contrast AF, the phase difference focus detection and the phase difference AF through the AF part 42. The system controller 50 as a charge accumulation controller controls, through the timing generator 18, charge accumulation timings of the image sensor 14 and reading timings of the analog image pickup signal corresponding to the accumulated charges. Moreover, the system controller 50 controls a focus driver 342 in the interchangeable lens 300 through the lens controller 346 in the contrast AF and the phase difference AF to move the focus lens in a direction of an optical axis (hereinafter referred to as “an optical axis direction”) of the image-taking optical system 311. Thereby, autofocus (AF) is performed.

The camera 100 is provided with a zoom switch (not shown). The system controller 50 controls a zoom driver 340 in the interchangeable lens 300 through the lens controller 346 in response to a user's operation of the zoom switch to move the zoom lens in the optical axis direction. Thereby, zooming (variation of magnification) is performed.

The photometry part 46 detects information on luminance of the object (hereinafter referred to as “object luminance information”) from the video signal or digital image pickup signal input thereto.

The system controller 50 controls, in the still image capturing, operations of a shutter 12 through a shutter controller 36 on the basis of the object luminance information. Moreover, the system controller 50 controls, in the moving image capturing, a charge accumulation time and a sensitivity of the image sensor 14 on the basis of the object luminance information. In addition, the system controller 50 controls an aperture stop driver 344 in the interchangeable lens 300 through the lens controller 346 on the basis of the object luminance information. Thereby, an aperture diameter of the aperture stop 312 is changed such that a quantity of light reaching the image sensor 14 from the image-taking optical system 311 is adjusted. Such control of the operations of the shutter 12, the charge accumulation time and sensitivity of the image sensor 14 and the aperture diameter of the aperture stop 312 is called “AE” (auto exposure).

Moreover, the system controller 50 controls light emission of a flash 48 when the luminance of the object is dark.

The system controller 50 communicates with the lens controller 346 through the above-mentioned communication terminals 122 and 322 and the interfaces 38 and 338, and thereby acquires, from the lens controller 346, position information of the zoom lens, the focus lens and the aperture stop 312 and various lens information such as optical information of the image-taking optical system 311. A nonvolatile memory 348 in the interchangeable lens 300 stores the optical information of the image-taking optical system 311 and identification information of the interchangeable lens 300.

The memory controller 22 controls the A/D converter 16, the timing generator 18, the image processor 20, an image display memory 24, the D/A converter 26, a memory 30 and a compressing/decompressing part 32. The video signal produced by the image processor 20 or the digital image pickup signal from the A/D converter 16 is written in the image display memory 24 or the memory 30 through the memory controller 22.

Reference numeral 28 denotes an image display part constituted by an LCD or the like. Displaying video (hereinafter referred to as “EVF video”) written in the image display memory 24 is sent to the image display part 28 through the D/A converter 26. Displaying the EVF video on the image display part 28 achieves an electronic viewfinder (EVF).

The memory 30 stores the produced video signal (moving image) and still image as image data. Moreover, the memory 30 is used as a work area of the system controller 50.

The compressing/decompressing part 32 reads the image data from the memory 30 to perform a compression process and a decompression process by adoptive discrete cosine transformation (ADCT) or the like, and writes the data after the compression process or the decompression process into the memory 30 again.

Reference numeral 52 denotes a memory that stores data such as constants, variables and computer programs for various operations of the system controller 50.

Reference numeral 54 denotes an information display part that outputs information showing operation states of the camera 100 and messages by using characters, images or voices. The information display part 54 is constituted by a liquid crystal display element or a speaker. The information display part 54 displays part of the information in a viewfinder frame through the optical viewfinder 104.

Reference numeral 56 denotes a nonvolatile memory such as an EEPROM that can electrically record and delete data.

Reference numeral 60 denotes a mode dial that is operated by the user to selectively set one of operation modes such as a still image capturing mode, a moving image capturing mode and a playing mode.

Reference numeral 62 denotes an image capturing preparation switch (SW1) that is turned on in response to a first stroke operation (half-press operation) of a shutter button (not shown) to cause the camera 100 to start image capturing preparation operations such as the AE based on the photometry result (object luminance information) and the AF.

Reference numeral 64 denotes an image capturing start switch (SW2) that is turned on in response to a second stroke operation (full press operation) of the shutter button to cause the camera 100 to start an image capturing (recording) operation. The image capturing operation includes an open/close operation of the shutter 12 in the still image capturing, an image data (still image or moving image) producing operation of the image processor 20 based on the image pickup signal from the image sensor 14, and a writing operation to write the image data to the memory 30. The image capturing operation further includes a reading operation to read the image data from the memory 30, compresses at the compressing/decompressing part 32 and then records the compressed image data to a recording medium 200 or 210. Such an image capturing operation is also an operation for acquiring a recording image.

Reference numeral 66 denotes an image display ON/OFF switch that is operated by the user to turn on and off the display on the image display part 28.

Reference numeral 68 denotes a quick review ON/OFF switch that is operated by the user. The quick review is a function of displaying the still image acquired by the still image capturing for a predetermined time immediately after the still image capturing.

Reference numeral 70 denotes an operating part including various buttons, a touch panel and the like. The operating part 70 is operated by the user to display a menu screen for function selection and various settings of the camera 100 and to decide a menu item.

Reference numeral 98 denotes a recording medium detector that detects whether or not the recording media 200 and 210 are attached to the camera 100.

Reference numeral 80 denotes a power supply controller including a battery detector to detect a remaining battery level, a DC-DC converter to convert a power-supply voltage (battery voltage) to a predetermined operation voltage and a switching part that switches a block to which the operation voltage is supplied.

Reference numeral 86 denotes a battery as a primary battery such as an alkaline battery or a lithium battery, or as a secondary (rechargeable) battery such as a NiMH battery or a Li battery. Reference numerals 82 and 84 denote connectors to electrically connect the battery 86 to the camera 100.

Reference numerals 90 and 94 denote interfaces to allow communication between the recording media 200 and 210 and the camera 100. Reference numerals 92 and 96 denote connectors to be connected to the recording media 200 and 210.

Reference numeral 110 denotes a communicating part including a communication function by RS232C, USB, IEEE1394 or wireless communication. Reference numeral 112 denotes a connector to connect other devices, such as antenna for wireless communication, to the camera 100 through the communicating part 110.

The recording media 200 and 210 respectively include recording part 202 and 212 to which the compressed image data and sound data output from the camera 100 are recorded, interfaces 204 and 214 to allow communication with the camera 100, and connectors 206 and 216 to electrically connect the camera 100 with the interfaces 204 and 214. The recording part 202 and 212 are constituted by semiconductor memories, optical discs or the like.

Next, description will be made of the contrast AF, the phase difference focus detection and the phase difference AF performed by the AF part 42 in the camera 100 by using the image sensor 14.

In the contrast AF, the AF part 42 produces a signal showing a contrast evaluation value (also referred to as “AF evaluation value”) by using a high-frequency component extracted from the video signal, and moves the focus lens such that the contrast evaluation value may become a peak value (maximum value). The position of the focus lens where the contrast evaluation value becomes the peak value is an in-focus position where an in-focus state of the image-taking optical system 311 is obtained.

Moreover, in the contrast AF, the AF part 42 reciprocally moves the focus lens in the optical axis direction with a minute movement amount, that is, causes the focus lens to performs so-called wobbling, in order to determine a movement direction of the focus lens in which the contrast evaluation value increases to the peak value (the movement direction is hereinafter referred to as “an in-focus direction”). Furthermore, the AF part 42 always causes the focus lens to perform the wobbling also after the in-focus state has been obtained to move the focus lens in a direction where the contrast evaluation value becomes higher, thereby keeping the in-focus state.

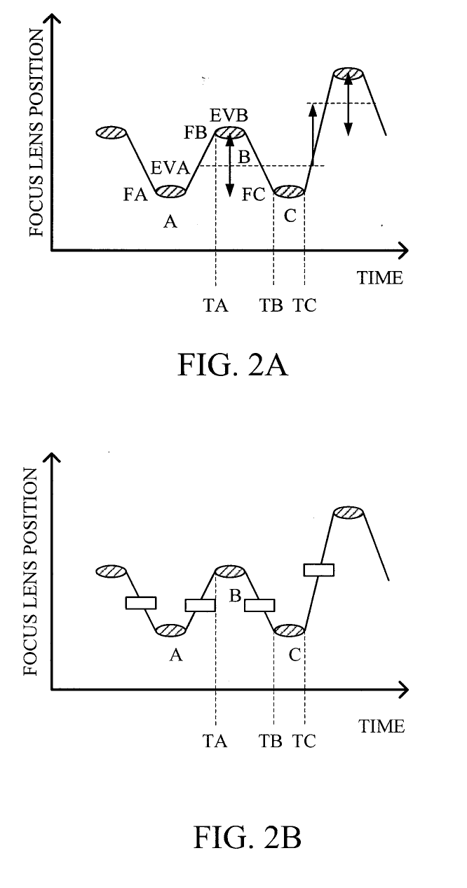

FIG. 2A shows the contrast evaluation value being varied by the wobbling of the focus lens. A horizontal axis shows time, and a vertical axis shows the position of the focus lens (hereinafter also referred to as “a focus lens position”). A solid line in the figure shows a movement trajectory of the focus lens, and hatched ellipses show charge accumulation periods of the image sensor 14 in the wobbling.

The system controller 50 causes the image sensor 14 to alternately and repeatedly perform charge accumulation operations (first charge accumulation operations) for calculating the contrast evaluation value and calculation (output) of the contrast evaluation value at a predetermined cycle. The charge accumulation operation of the image pickup element 14 for calculating the contrast evaluation value corresponds to charge accumulation operation (image producing charge accumulation operation) for producing each frame of the video signal.

In FIG. 2A, at a time TA, the AF part 42 takes in the image pickup signal corresponding to electric charges accumulated by the image sensor 14 in a charge accumulation period A at a focus lens position FA, and calculates a contrast evaluation value EVA from the taken image pickup signal. The focus lens is controlled by the system controller 50 to be moved to a position FB at the time TA, a subsequent charge accumulation period B is stated after the time TA.

Next, the AF part 42 takes in the image pickup signal corresponding to electric charges accumulated by the image sensor 14 in a charge accumulation period B at the focus lens position FB, and calculates a contrast evaluation value EVB from the taken image pickup signal. The focus lens is moved to a position FC at the time TB, a next charge accumulation period C is stated after the time TB.

Then, the AF part 42 compares the contrast evaluation values EVA and EVB at the time TC (that is, a finish time of the charge accumulation period C). If EVB is larger than EVA, the AF part 42 shifts a center of the reciprocal movement of the focus lens in the wobbling (the center is hereinafter referred to as “a wobbling amplitude center”), which has been set to a position between the focus lens positions FA (FC) and FB until then, toward the position FB. On the other hand, if EVA is larger than EVB, the AF part 42 does not shift the wobbling amplitude center. The AF part 42 continuously performs such processes, which makes it possible to always move the focus lens in the in-focus direction.

The amplitude of the wobbling is set based on an F-number of the image-taking optical system 311, a diameter 6 of a permissible circle of confusion of the camera 100 and the like.

Next, description will be made of the phase difference focus detection and the phase difference AF. FIG. 2B shows a relationship between the charge accumulation periods A to C of the image sensor 14 for the contrast AF shown in FIG. 2A and charge accumulation periods of the image sensor 14 for the phase difference focus detection. Periods shown by rectangular marks denote the charge accumulation periods for performing the phase difference focus detection (that is, for producing paired image signals described later).

As understood from FIG. 2B, the system controller 50 causes the image sensor 14 to perform a charge accumulation operation for the phase difference focus detection (second charge accumulation operation) in each period between two consecutive (previous and subsequent) ones of the charge accumulation operations for the contrast AF (first charge accumulation operations). In other words, the system controller 50 causes the image sensor 14 to perform the charge accumulation operation for the contrast AF and the charge accumulation operation for the phase difference focus detection at mutually different timings.

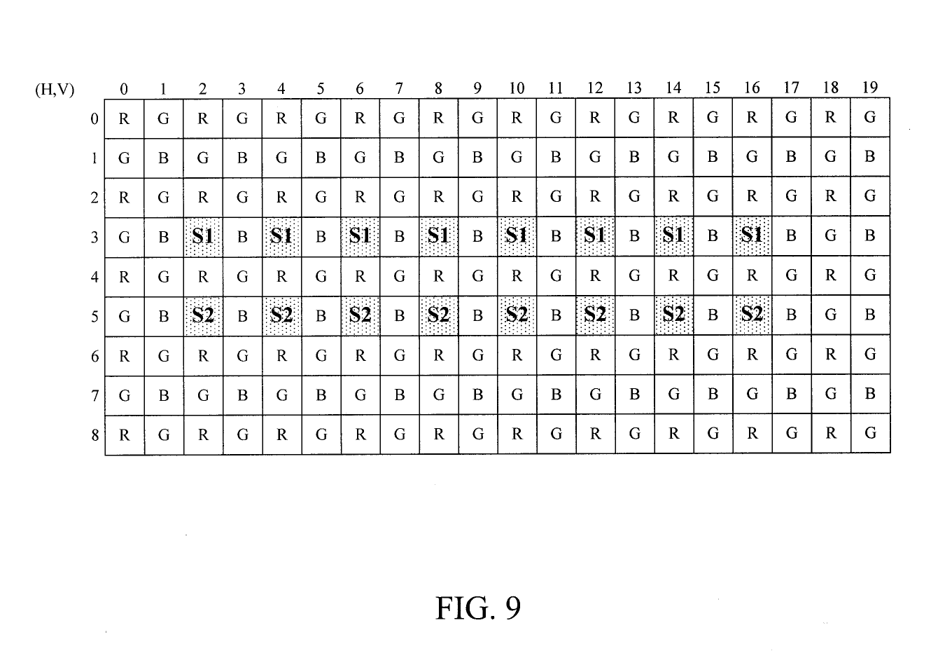

Next, description will be made of the structure of the image sensor 14 enabling the phase difference focus detection with reference to FIG. 9. The image sensor 14 has plural image pickup pixels (first pixels) shown by R, G and B in the figure and plural focus detection pixels (second pixels) S1 and S2 discretely arranged in the image pickup pixels R, G and B. Numbers in a horizontal direction H and a vertical direction V in the figure show coordinates of the position of each pixel.

Reference characters R, G, and B denote colors (red, green and blue) of color filters provided to the respective image pickup pixels. The image pickup pixels R, G and B photoelectrically convert the object image formed by the image-taking optical system 311 and allow the image data to be produced by using the output signal (image pickup signal) therefrom.

On the other hand, the focus detection pixels S1 and S2 divide the light flux from the image-taking optical system 311 (that is, divide an exit pupil of the image-taking optical system 311) by an effect of a light-shielding layer provided for the focus detection pixels S1 and S2 and having two apertures each being decentered with respect to a center of a microlens described later. The focus detection pixels S1 and S2 photoelectrically convert paired object images formed by the pupil-divided paired light fluxes. When performing the phase difference focus detection, the AF part 42 combines output signals from the plural focus detection pixels S1 to produce an image signal and combines output signals from the plural focus detection pixels S2 to produce another image signal, and then calculates a phase difference between the two (paired) image signals.

The outputs (pixel values) of the focus detection pixels S1 and S2 cannot be used directly for producing the image data. Therefore, the image processor 20 interpolates pixel values at positions of the focus detection pixels S1 and S2 by interpolation calculation using the pixel values of the image pickup pixels R, G and B arranged around the focus detection pixels S1 and S2, and then produces the image data by using the interpolated pixel values.

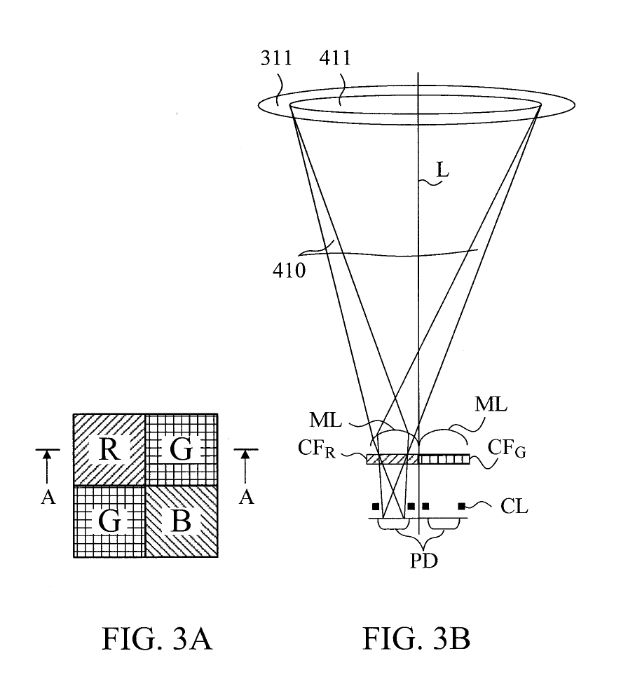

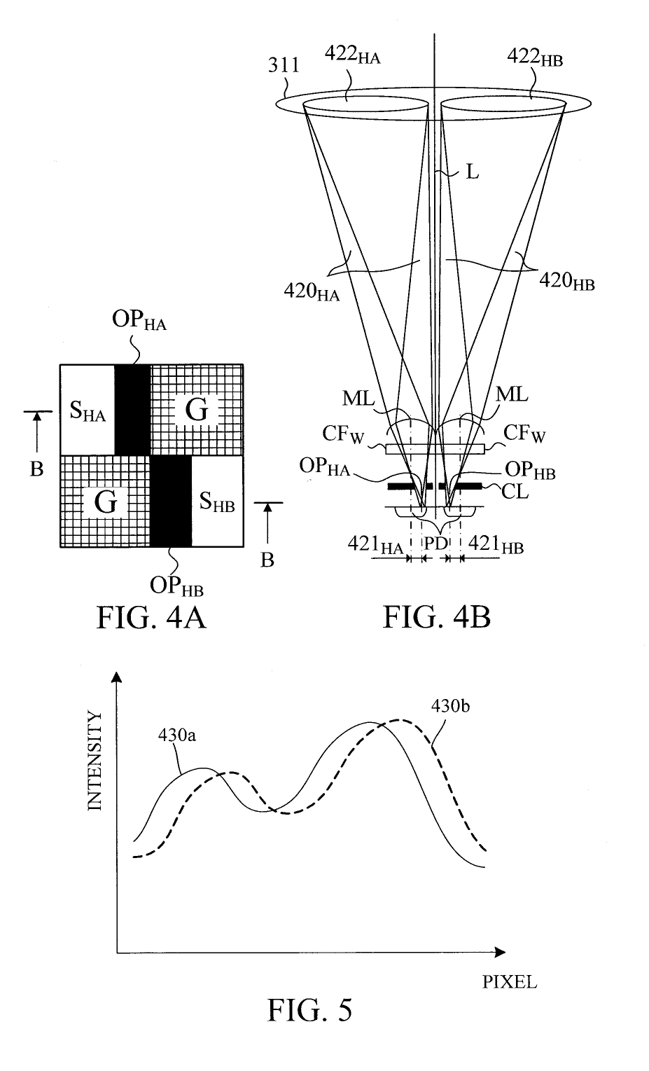

FIGS. 3A and 3B show the arrangement and the structure of the image pickup pixels, and FIGS. 4A and 4B show the arrangement and the structure of the focus detection pixels. In this embodiment, as shown in FIG. 3A, the image sensor (for example, a CMOS sensor) 14 employs a Bayer arrangement in which, of 4 image pickup pixels arranged in 2 rows×2 columns, the 2 image pickup pixels diagonally arranged have the G color filters and the remaining 2 image pickup pixels have the R and B color filters. As shown in FIG. 4A, the 2 image pickup pixels having the R and B color filters are replaced by the focus detection pixels.

FIG. 3A shows the arrangement of the above-mentioned 4 image pickup pixels arranged in 2 rows×2 columns near a center of the image sensor 14, that is, near the optical axis of the image-taking optical system 311. FIG. 3B shows a cross section cut along a line A-A in FIG. 3A. Reference character L denotes the optical axis of the image-taking optical system 311.

In FIG. 3B, reference character ML denotes an on-chip microlens placed at a front end of each pixel, reference character CF_{R} denotes the R color filter, and reference character CF_{G} denotes the G color filter. Reference character PD (photo diode) denotes a photoelectric conversion part of the CMOS sensor. Reference character CL (contact layer) denotes a wiring layer for forming signal lines to transmit various signals in the CMOS sensor.

The on-chip microlens ML and the photoelectric conversion part PD of the image pickup pixel are configured to capture a light flux 410 passing through an exit pupil 411 of the image-taking optical system 311 as effectively as possible. Although FIG. 3B shows only the structure of the image pickup pixels R and G and the light flux 410 entering the image pickup pixel R, the image pickup pixel B has the same structure as those of the image pickup pixels R and G, and a light flux similarly enters each of the image pickup pixels G and B to that entering the image pickup pixel R.

FIG. 4A shows the pixel arrangement in which the image pickup pixels R and G of the above-mentioned image pickup pixels arranged in 2 rows×2 columns near the center of the image sensor 14 are replaced by a focus detection pixel S_{HA} corresponding to S1 in FIG. 9 and a focus detection pixel S_{HB} corresponding to S2. FIG. 4B shows a cross section cut along a line B-B in FIG. 4A. Reference character L denotes the optical axis of the image-taking optical system 311.

In FIG. 4B, the microlens ML and the photoelectric conversion part PD have the same structures as those of them shown in FIG. 3B. Since the output signal of the focus detection pixel is not used for producing the image data as described above, a transparent film C_{FW} (white film) is provided to the focus detection pixel, instead of the color filter for color separation.

Moreover, since the focus detection pixels divide the exit pupil of the image-taking optical system 311, the apertures formed in the wiring layer CL as the light-shielding layer are decentered to one and another directions with respect to the center of the microlens ML. Specifically, the aperture OP_{HA} of the focus detection pixel S_{HA} is decentered to the right with respect to the center of the microlens ML by a decentering amount 421_{HA}. Therefore, the photoelectric conversion part PD of the focus detection pixel S_{HA} receives only a light flux 420_{HA} passing through an exit pupil area 422_{HA} located to the left from the optical axis L.

On the other hand, the aperture OP_{HB} of the focus detection pixel S_{HB} is decentered to the left with respect to the center of the microlens ML by a decentering amount 421_{HB}. Therefore, the photoelectric conversion part PD of the focus detection pixel S_{HB} receives only a light flux 420_{HB} passing through an exit pupil area 422_{HB} located to the right from the optical axis L. The decentering amount 421_{HB} is equal to the decentering amount 421_{HA}.

Thus, the focus detection pixels S_{HA} and S_{HB} respectively receive the light fluxes 420_{HA} and 420_{HB} passing through the mutually different exit pupil areas 422_{HA} and 422_{HB} of the image-taking optical system 311 by the decentering of the apertures OP_{HA} and OP_{HB} with respect to the microlens ML.

A plurality of the focus detection pixels S_{HA} and a plurality of the focus detection pixels S_{HB} are arranged in the horizontal direction and the vertical direction. The plurality of the focus detection pixels S_{HA} photoelectrically convert an object image (A image) formed thereon to provide an image signal corresponding to the A image. The plurality of the focus detection pixels S_{HB} photoelectrically convert an object image (B image) formed thereon to provide an image signal corresponding to the B image. Then, detecting a phase difference between the paired image signals (that is, a relative positional difference between the A image and the B image) enables calculation of a defocus amount of the image-taking optical system 311. Moving the focus lens such that the defocus amount may reduce toward 0, that is, an in-focus state may be obtained can perform the phase difference AF.

Although FIGS. 4A and 4B show the focus detection pixels in a central area (area near the center) of the image sensor 14, in areas other than the central area the microlens ML and the apertures OP_{HA} and OP_{HB} in the wiring layer CL are decentered in a different manner from that shown in FIG. 4B, thereby also making it possible to divide the exit pupil in those areas.

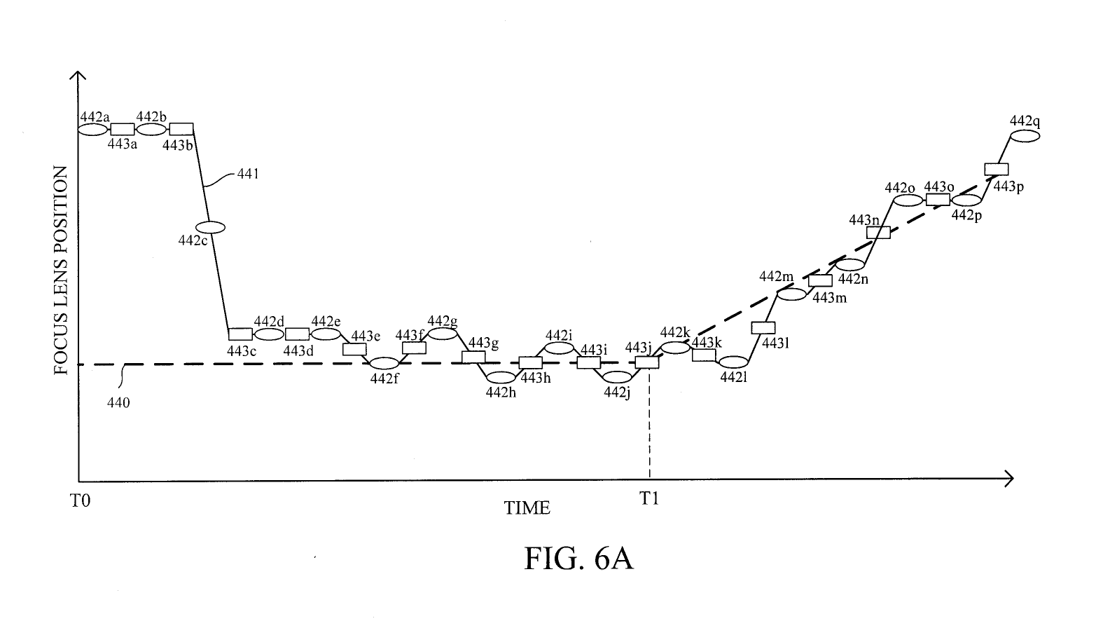

FIG. 5 shows an example of the image signal 430a corresponding to the A image and the image signal 430b corresponding to the B image. In FIG. 5, a horizontal axis shows an arrangement direction of the focus detection pixels S_{HA} and S_{HB}, and a vertical axis shows intensity of the image signals 430a and 430b.

FIG. 5 shows a defocused state of the image-taking optical system 311 where the image signals 430a and 430b are displaced from each other. The AF part 42 calculates the phase difference that is a displacement amount of the image signals 430a and 430b and a displacement direction thereof by correlation calculation, and further calculates a defocus amount and a defocus direction of the image-taking optical system 311.

This embodiment determines the in-focus direction in a state where the image-taking optical system 311 is significantly defocused by using information on the defocus direction obtained by the phase difference focus detection, and moves the focus lens to a position near the in-focus position at a high speed on the basis of information on the defocus amount by the phase difference AF. Then, this embodiment achieves an accurate in-focus state from the position near the in-focus position by the contrast AF. This AF process enables reduction of a length of time required for obtaining an accurate in-focus state from the significantly defocused state.

Moreover, this embodiment continuously determines the in-focus direction from the information on the defocus direction obtained by the phase difference focus detection also while the in-focus state is kept by the contrast AF. This continuous determination of the in-focus direction can move, even if the object moves to cause the defocused state, the focus lens so as to rapidly follow the movement of the object to obtain the in-focus state again.

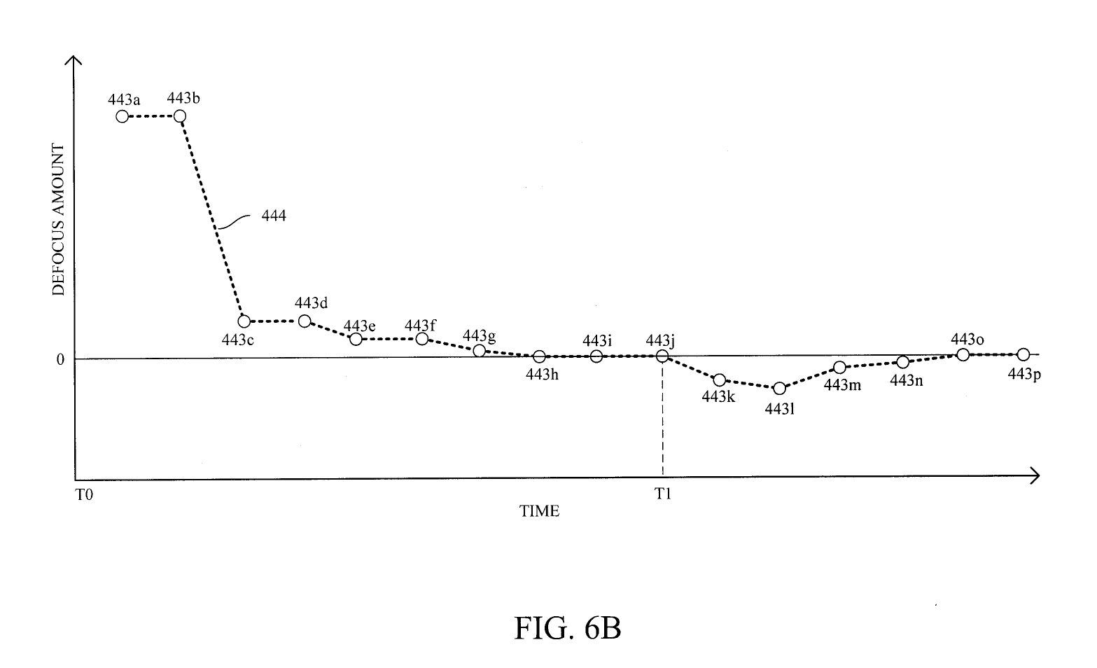

FIGS. 6A and 6B show that the focus lens is moved to follow a moving object by a hybrid AF in this embodiment using the contrast AF and the phase difference AF. FIG. 6A shows the focus lens position changing with time. In FIG. 6A, a horizontal axis shows time, and a vertical axis shows the focus lens position.

A broken line 440 shows an example of changes of the in-focus position of the focus lens to obtain the in-focus state for the object whose position with respect to an image pickup surface of the image sensor 14 changes. In this example, the object stands still with respect to the image pickup surface from a time T0 to a time T1, and moves with respect to the image pickup surface after the time T1 such that the in-focus position of the focus lens may change at a constant speed.

A solid line 441 shows the movement of the focus lens to follow the object by the hybrid AF. Ellipsoidal marks 442a-442q show charge accumulation periods of the image sensor 14 for the contrast AF (that is, for calculation of the contrast evaluation value). In the following description, each of these charge accumulation periods is referred to as “a contrast charge accumulation period”, and a charge accumulation operation performed in the contrast charge accumulation period is referred to as “a contrast charge accumulation operation”. The contrast charge accumulation operation is also a charge accumulation operation to produce the video signal, and it is performed by the image pickup pixels of the image sensor 14.

On the other hand, rectangular marks 443a-443o show charge accumulation periods of the image sensor 14 for the phase difference focus detection (that is, for production of the image signals). In the following description, each of these charge accumulation periods is referred to as “a phase difference charge accumulation period”, and a charge accumulation operation performed in the phase difference charge accumulation period is referred to as “a phase difference charge accumulation operation”. The phase difference charge accumulation operation is performed by the focus detection pixels of the image sensor 14.

In addition, in the following description, a timing of reading the accumulated electric charges and a timing of calculating the contrast evaluation value and a timing of calculating the defocus amount are simply described as “in the contrast charge accumulation period” and “in the phase difference charge accumulation period”. However, these timings actually may be any of a timing immediately before the charge accumulation period, a start timing of the charge accumulation period, an intermediate timing in the charge accumulation period and an end timing of the charge accumulation period.

Firstly, the contrast charge accumulation operation is performed in the contrast charge accumulation period 442a. Thereafter, the image pickup signal corresponding to the electric charges accumulated in the contrast charge accumulation period 442a is read in the phase difference charge accumulation period 443a, and then the contrast evaluation value is calculated in the subsequent contrast charge accumulation period 442b.

On the other hand, the phase difference charge accumulation operation is performed in the phase difference charge accumulation period 443a. Thereafter, the image pickup signal corresponding to the electric charges accumulated in the phase difference charge accumulation period 443a is read in the contrast charge accumulation period 442b, and then the phase difference, that is, the defocus amount is calculated in the subsequent phase difference charge accumulation period 443b. If the defocus amount is larger than a predetermined value Dth, the focus lens is moved according to the defocus amount within a period including the subsequent contrast charge accumulation period 442c (in other words, in a period to the subsequent phase difference charge accumulation period 443c).

Thus, after the focus lens has been moved to a position near the in-focus position by the result of the phase difference focus detection, the focus lens is moved closer to a more accurate in-focus position by the contrast AF and kept in the in-focus state (that is, a so-called “in-focus following operation” is performed). Between two consecutive ones of the contrast charge accumulation operations (that is, previous and subsequent contrast charge accumulation operations), the phase difference charge accumulation operation is also performed.

The calculation of the defocus amount from the image pickup signal corresponding to the electric charges accumulated in the previous phase difference charge accumulation period 443b is also performed in the subsequent phase difference charge accumulation period 443c. However, even though the calculated defocus amount is larger than the predetermined value Dth, if a change amount of the defocus amount between the phase difference charge accumulation periods 443a and 443b is equal to or smaller than a predetermined change amount ΔDth, the focus lens in not moved in a period including the contrast charge accumulation period 442d.

Then, after the contrast charge accumulation operation has been performed in the contrast charge accumulation period 442d, the image pickup signal corresponding to the electric charges accumulated in that period 442d is read in the phase difference charge accumulation period 443d, and the contrast evaluation value is calculated in the subsequent contrast charge accumulation period 442e.

In addition, in the phase difference charge accumulation period 443d, the defocus amount is calculated from the image pickup signal corresponding to the electric charges accumulated in the phase difference charge accumulation period 443c. If the defocus amount is equal to or smaller than the predetermined value Dth, the contrast AF with the wobbling of the focus lens is performed as described with reference to FIG. 2A.

FIG. 6A shows an example of the contrast AF with the wobbling of the focus lens in the contrast charge accumulation periods 442e-442q. Also during this contrast AF, the phase difference charge accumulation operations and the calculation of the defocus amount are performed in the phase difference charge accumulation periods 443e-443p.

FIG. 6B shows changes of the defocus amount detected by the phase difference focus detection with the changes of the focus lens position shown in FIG. 6A. Monitoring the changes of the defocus amount makes it possible to perform the in-focus following operation for the moving object. This embodiment performs, as described with reference to FIG. 2B, the phase difference charge accumulation operations during the movement of the focus lens for the wobbling. However, the movement amount of the focus lens for the wobbling is a minute amount. Therefore, the defocus amount calculated from the image pickup signal corresponding to the electric charges accumulated in the phase difference charge accumulation periods 443e-443j during a period where the wobbling is performed (442e-442j) receives almost no influence of the wobbling. Thus, it is possible to prevent an erroneous determination regarding a still object as a moving object due to the phase difference focus detection during the wobbling.

In other words, during the wobbling period 442e-442j, the defocus amount calculated from the image pickup signal corresponding to the electric charges accumulated in the phase difference charge accumulation periods 443e-443j becomes equal to or smaller than the predetermined value Dth, which results in the in-focus following operation by only the contrast AF.

Next, in the contrast charge accumulation period 442k, the defocus amount is calculated from the image pickup signal corresponding to the electric charges accumulated in the phase difference charge accumulation period 443j (time T1). Although the object moves in the contrast charge accumulation period 442k, the defocus amount corresponding to the movement of the object cannot be calculated by the charge accumulation operation in the phase difference charge accumulation period 443j.

Then, in the subsequent phase difference charge accumulation period 443l, the defocus amount is calculated from the image pickup signal corresponding to the electric charges accumulated in the phase difference charge accumulation period 443k. If the change amount of the currently calculated defocus amount from the previously calculated defocus amount is larger than the predetermined change amount ΔDth, the wobbling amplitude center of the focus lens is shifted to a position according to the change amount.

In addition, also in the phase difference charge accumulation period 443m, the defocus amount is calculated from the image pickup signal corresponding to the electric charges accumulated in the phase difference charge accumulation period 443l. The change amount of the currently calculated defocus amount from the previously calculated defocus amount is larger than the predetermined change amount ΔDth, so that the wobbling amplitude center is shifted.

Next, in the phase difference charge accumulation period 443n, the defocus amount is calculated from the image pickup signal corresponding to the electric charges accumulated in the phase difference charge accumulation period 443m. Since the change amounts larger than the predetermined change amount ΔDth have been detected consecutively three times by the charge accumulation operations in the phase difference charge accumulation periods 443k, 443l and 443m, this embodiment calculates a predicted defocus amount based on the three calculation results of the defocus amount, and shifts the wobbling amplitude center according to the change amount of the predicted defocus amount from the previously calculated defocus amount.

In the subsequent periods (443o and 443p), this embodiment performs the wobbling of the focus lens with shifting of the wobbling amplitude center according to the predicted defocus amount. The in-focus following operation by the contrast AF (hereinafter also referred to as “wobbling AF”) for the moving object is thus performed.

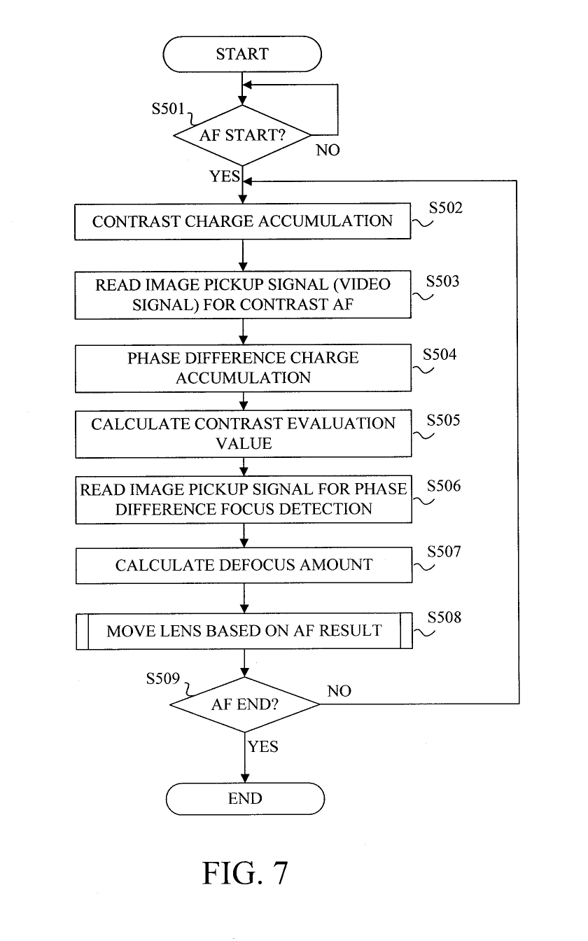

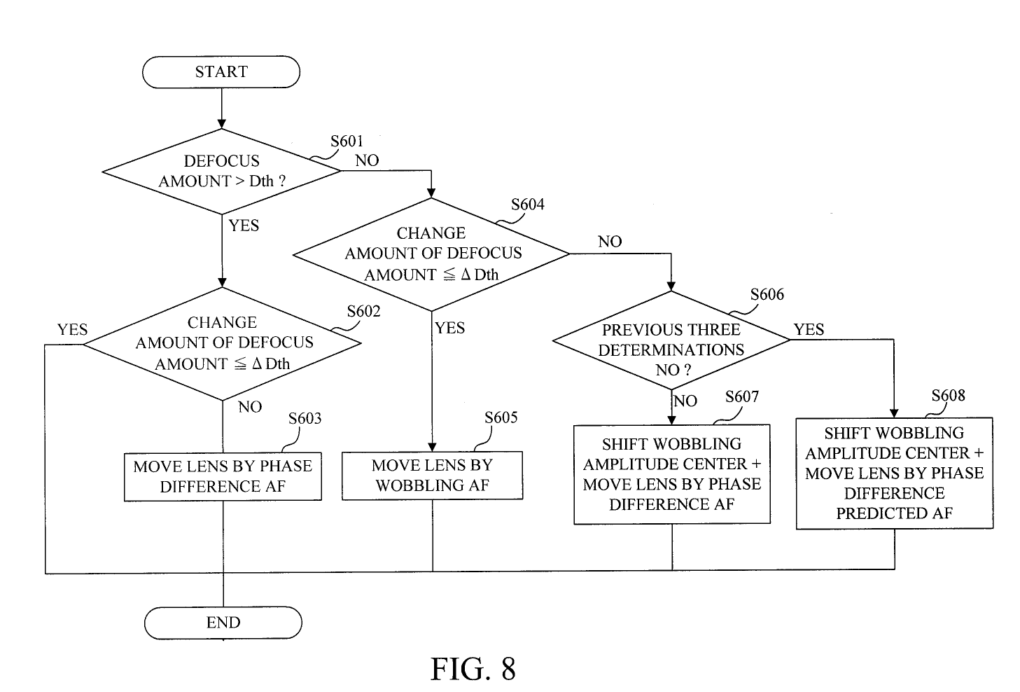

Next, description will be made of a process for the hybrid AF (hereinafter referred to as “an AF process”) in the moving image capturing of the above-described camera 100 with reference to flowcharts shown FIGS. 7 and 8. This AF process is executed by the system controller 50 and the AF part 42 according to a computer program stored in the system controller 50.

FIG. 7 shows the entire AF process. In response to user's input of an AF start instruction through the operating part 70 at step S501, the system controller 50 proceeds to step S502.

At step S502, the system controller 50 causes the image sensor 14 to perform the contrast charge accumulation operation for the contrast AF (for producing the video signal). The image processor 20 produces the video signal on the basis of the image pickup signal from the image sensor 14.

Next, at step S 503, the AF part 42 reads the video signal (frame) produced by the image processor 20 through the system controller 50.

On the other hand, at step S504, the system controller 50 causes the image sensor 14 to perform the phase difference charge accumulation operation for the phase difference focus detection (for producing the paired image signals).

Next, at step S505, the AF part 42 calculates the contrast evaluation value by using the video signal read at step S503.

Next, at step S506, the AF part 42 reads the image pickup signal corresponding to the electric charges accumulated by the phase difference charge accumulation operation in the image sensor 14 through the A/D converter 16, the image processor 20 and the system controller 50.

Next, at step S507, the AF part 42 calculates the defocus amount obtainable by the phase difference focus detection.

Next, at step S508, the AF part 42 and the system controller 50 perform the hybrid AF through the focus driver 342 on the basis of the contrast evaluation value and the defocus amount respectively calculated at steps S505 and S507.

Finally, at step S509, the system controller ends the AF process if an AF end instruction is input by the user through the operating part 70, and returns to step S 502 to continue the AF process if no AF end instruction is input.

Next, detailed description will be made of the process performed at step D508 with reference to the flowchart shown in FIG. 8. Firstly, at step S601, the AF part 42 determines whether or not the defocus amount calculated by the phase difference focus detection is larger than the predetermined value Dth. The AF part 42 proceeds to step S602 if the defocus amount is larger than the predetermined value Dth, and proceeds to step S604 if the defocus amount is equal to or smaller than the predetermined value Dth.

At step S602, the AF part 42 determines whether or not the change amount of the currently calculated defocus amount from the previously calculated defocus amount is equal to or smaller than the predetermined change amount ΔDth. The AF part 42 ends the process without moving the focus lens if the change amount is equal to or smaller than the predetermined change amount ΔDth, and proceeds to step S603 if the change amount is larger than the predetermined change amount ΔDth.

At step S603, the AF part 42 and the system controller 50 move the focus lens on the basis of the defocus amount.

Moreover, at step S604, the AF part 42 determines, as at step S602, whether or not the change amount of the currently calculated defocus amount from the previously calculated defocus amount is equal to or smaller than the predetermined change amount ΔDth. The AF part 42 proceeds to step S605 if the change amount is equal to or smaller than the predetermined change amount ΔDth, and proceeds to step S606 if the change amount is larger than the predetermined change amount ΔDth.

At step S605, the AF part 42 and the system controller 50 perform the wobbling AF (contrast AF).

Moreover, at step S606, the AF part 42 determines whether or not the results of the previous three determinations made at step S604 have been “No” (that is, the change amount of the currently calculated defocus amount from the previously calculated defocus amount is larger than the predetermined change amount ΔDth). The AF part 42 proceeds to step S607 if No at step S606, and proceeds to step S608 if Yes at step S606.

At step S607, the AF part 42 calculates the shift amount of the wobbling amplitude center by using the defocus amount calculated by the phase difference focus detection. Then, the AF part 42 shifts the wobbling amplitude center by the calculated shift amount to continue the wobbling AF.

On the other hand, at step S608, the AF part calculates the predicted defocus amount from the previous three calculation results of the defocus amount, and shifts the wobbling amplitude center according to the change amount of the predicted defocus amount from the previous calculated defocus amount to continue the wobbling AF. Then, the AF part 42 proceeds to step S509 in FIG. 7.

As described above, this embodiment can perform good in-focus following operation for the moving object with the combination of the wobbling AF (contrast AF) and the phase difference focus detection. Moreover, this embodiment controls the timings of the phase difference charge accumulation operations such that the calculated defocus amount receives almost no influence of the wobbling of the focus lens by the wobbling AF. This timing control prevents an erroneous determination regarding a still object as a moving object, which makes it possible to obtain and keep an accurate in-focus state also for the moving object.

Although this embodiment has described the lens-interchangeable single-lens reflex camera, the hybrid AF described in this embodiment can be applied also to a lens-integrated camera.

Moreover, this embodiment has described the case where the phase difference focus detection and the phase difference AF are performed by using the output signal from the focus detection pixel provided in the image sensor (that is, by using the image sensor as a focus detection element). However, the phase difference focus detection and the phase difference AF may be performed by using a photoelectric conversion element as the focus detection element provided separately from the image sensor. In this case, for example, the photoelectric conversion element receives divided (paired) light fluxes of a light flux exiting from the image-taking optical system, transmitted through a main mirror and then reflected by a sub-mirror placed at the back of the main mirror. The photoelectric conversion element photoelectrically converts paired object image formed by the paired light fluxes, thereby producing paired image signals for the phase difference focus detection and the phase difference AF.

In addition, this embodiment has described the case of performing the contrast AF (wobbling AF) with the wobbling of the focus lens. However, such wobbling AF may be performed by wobbling of the image sensor in the optical axis direction. In other words, the phase difference charge accumulation operations may be performed during the reciprocal movement of at least one of the focus lens (focus optical element) and the image sensor.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-264667, filed on Nov. 29, 2010 which is hereby incorporated by reference herein in its entirety.

What is claimed is:

1. An image pickup apparatus comprising:
an image sensor photoelectrically converting an object image formed by an image-taking optical system;
a first focus controller configured to perform first focus control with a contrast detection method by using a first signal output from the image sensor;
a second focus controller configured to detect a focus state of the image-taking optical system with a phase difference detection method by using a second signal output from a focus detection element that is one of the image sensor and a photoelectric conversion element provided separately from the image sensor, and configured to perform second focus control based on the detected focus state; and
a charge accumulation controller configured to cause the image sensor to alternately and repeatedly perform a first charge accumulation operation for producing the first signal and output of the first signal, and configured to cause the focus detection element to perform a second charge accumulation operation for producing the second signal in a period between two consecutive ones of the first charge accumulation operations.

2. An image pickup apparatus according to claim 1, wherein the first focus controller is configured to move a movable member that is at least one of a focus optical element included in the image-taking optical system and the image sensor reciprocally in an optical axis direction, and
wherein the charge accumulation controller is configured to cause the focus detection element to perform the second charge accumulation operation during the reciprocal movement of the movable member.

3. An image pickup apparatus according to claim 1, wherein the first focus controller is configured to move a movable member that is at least one of a focus optical element included in the image-taking optical system and the image sensor reciprocally in an optical axis direction, and
wherein the first focus controller is configured to shift a center of the reciprocal movement of the movable member depending on the focus state detected by the phase difference detection method.

4. An image pickup apparatus according to claim 1, wherein the image sensor includes first pixels photoelectrically converting the object image to perform the first charge accumulation operation and an image producing charge accumulation operation for producing an image signal, and includes second pixels photoelectrically converting divided light fluxes of a light flux from the image-taking optical system to perform the second charge accumulation operation.

5. A control method of an image pickup apparatus that includes an image sensor photoelectrically converting an object image formed by an image-taking optical system, the method comprising the steps of:
performing first focus control with a contrast detection method by using a first signal output from the image sensor;
detecting a focus state of the image-taking optical system with a phase difference detection method by using a second signal output from a focus detection element that is one of the image sensor and a photoelectric conversion element provided separately from the image sensor, and performing second focus control based on the detected focus state; and
causing the image sensor to alternately and repeatedly perform a first charge accumulation operation for producing the first signal and output of the first signal, and of causing the focus detection element to perform a second charge accumulation operation for producing the second signal in a period between two consecutive ones of the first charge accumulation operations.
